(19) United States
(12) Patent Application Publication
(10) Pub. No.: US 2003/0227118 A1
(43) Pub. Date: Dec. 11, 2003

(54) Single point attachment dual path suspension mount

(75) Inventor: George A. LaBeau, Beavercreek, OH (US)

Correspondence Address: DELPHI TECHNOLOGIES, INC., Legal Staff Mail Code: 482-204-450, 1450 W. Long Lake, P.O. Box 5052, Troy, MI, 48098, US

(73) Assignee: DELPHI TECHNOLOGIES INC.

(21) Appl. No.: 10/164,489

(22) Filed: Jun. 6, 2002

(51) Int. Cl. B60G 11/22; F16F 9/00

(52) U.S. Cl. 267/293; 267/219

(57) ABSTRACT

A mount assembly for connecting a damper rod to a motor vehicle tower comprises a mount housing, a nut, and a resilient cushion. The mount housing has a vertical portion extending through an opening in the tower, and a flange disposed on one side of the tower. The nut is disposed on a side of the tower opposite the one side, and is engaged with the vertical portion of the mount housing. The resilient cushion is disposed within the vertical portion of the mount housing, the damper rod extending through the resilient cushion assembly. A spring engaged with the tower is adapted to transfer loads from the motor vehicle to the tower.

### TECHNICAL FIELD OF THE INVENTION

This invention relates generally to a damper mount assembly, and relates more particularly to a single point attachment mount assembly for vehicle suspension dampers.

### BACKGROUND OF THE INVENTION

The typical vehicle suspension includes a damper in the form of a strut or a shock that is mounted between the sprung (body), and unsprung (wheel assembly) masses of the vehicle to dampen spring oscillations. The lower end of the damper is connected to the wheel assembly in a suitable manner, and the upper end is connected to the body structure of the vehicle body, usually at a tower, by an upper damper mount assembly. With conventional upper mounts, a coil spring supports the weight of the vehicle and creates a force that is proportional to the relative velocity between the wheel of the vehicle and the body, transferring loads to the mount. In addition, a jounce bumper acts as a stop for compression directed movement of the damper transferring loads to the mount. Since the damper is connected to the body by the upper mount, the upper mount must support the total weight of the vehicle and provide acceptable isolation. Achieving these properties requires proper tuning of the mount. Tuning is complicated by the fact that relatively high spring and jounce bumper loads have to be accommodated through the mount.

Conventional upper mounts include at least one resilient element, normally a rubber cushion, to isolate and reduce the transmission of input forces to the body. An upper mount is generally required to be firm enough to support the weight of the body while simultaneously resilient enough for isolation purposes. For certain inputs, deflection of the upper mount is desirable while for other inputs it is preferable for the upper mount to resist deflection. Single path upper mounts are known, wherein the actuator or damper rod and a coil spring seat are fastened together and the load path is through a single rubber cushion. The single rubber cushion accommodates the forces generated by both the actuator or damper and the cooperating coil spring. The rubber cushion is preloaded by the vehicle's weight. Dual path mounts are also known, wherein the actuator or damper rod and the coil spring seat are not fastened together and wherein the load path is through separate rubber cushion assemblies. A first rubber cushion assembly engages the coil spring and supports the vehicle's weight, and a second rubber cushion assembly engages the actuator or damper rod and is not preloaded by vehicle weight.

The conventional upper mount assembly is attached to the tower by a plurality of fasteners that are distributed around the mount near its outer perimeter. It is also known to secure the mount to the tower by placing components of the mount on opposite sides of the tower and capturing them by a nut threaded to a piston rod tenon of the damper. U.S. Pat. No. 6,161,822, the disclosure of which is hereby incorporated by reference, shows a similar single point attachment mount.

### SUMMARY OF THE INVENTION

The present invention is a mount assembly for connecting a damper rod to a motor vehicle tower. The mount assembly comprises a mount housing, a nut, and a resilient cushion. The mount housing has a vertical portion extending through an opening in the tower, and a flange disposed on one side of the tower. The nut is disposed on a side of the tower opposite the one side, and is engaged with the vertical portion of the mount housing. The resilient cushion is disposed within the vertical portion of the mount housing, the damper rod extending through the resilient cushion assembly. A spring engaged with the tower is adapted to transfer loads from the motor vehicle to the tower.

Accordingly, it is an object of the present invention to provide a mount assembly of the type described above that attaches to the tower at a single point.

Another object of the present invention is to provide a mount assembly of the type described above that accepts damper loads in shear.

Still another object of the present invention is to provide a mount assembly of the type described above that reduces product and assembly costs by the elimination of redundant fasteners as well as improved cycle time due to the reduction of repeated fastening actions on the assembly line.

Still another object of the present invention is to provide a mount assembly of the type described above that provides separate paths for vehicle loads and damper loads.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a cross-sectional view of a suspension mount assembly according to the present invention attached to a damper and a tower of a motor vehicle; and

FIG. 2 is an exploded view of the suspension mount assembly.

### DETAILED DESCRIPTION OF THE PRESENTLY PREFERRED EMBODIMENTS

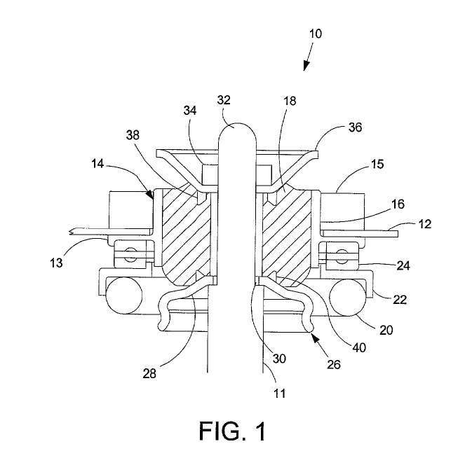

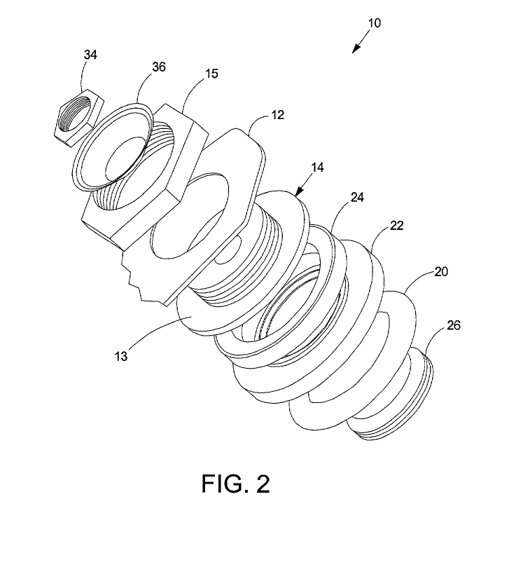

FIGS. 1 and 2 show one embodiment 10 of an upper suspension mount assembly for connecting a damper rod 11 to a vehicle body tower 12. In general, the mount assembly 10 is rigidly attached to the tower 12 at a single point, by trapping the tower between a flange 13 on mount housing 14 and a nut 15 engaged with external threads on a vertical portion 16 of the mount housing. In operation, the damper rod 11 is free to move relative to the tower 12, but no relative movement is intended between the mount housing 14 and the tower. This preferred illustrated embodiment provides for two separate load paths through the mount assembly 10. The loads created by the damper, and transmitted from the damper rod 11, pass through a resilient cushion assembly 18 to the vehicle tower 12. Other loads transmitted to the mount assembly 10, such as those that might be transmitted by the vehicle through a spring 20, pass through a spring seat 22 and a bearing 24 to the mount housing 14 and the vehicle tower 12.

The tower 12 is normally an inverted cup-shaped element with an annular sidewall, and is formed as part of a vehicle body stamping in a well-known manner. In a preferred embodiment the tower 12 is round or circularly shaped, and the mount assembly 10 is correspondingly shaped for mating reception therein so that no specific initial angular orientation of the mount assembly relative to the tower is required for assembly. The mount assembly 10 can of course adopt alternate shapes, such as oval or oblong, that may present some advantages in specific applications such as allowing the mount to have performance differentials (tunability) in the different motion directions of the vehicle suspension.

A lower rate washer 26 is preferably formed of an acceptably rigid material such as metal, and includes a shoulder 28 around an opening 30. The damper piston rod 11 abuts the shoulder 28, and a tenon 32 of the rod extends through the opening 30. A nut 34 is threadingly engaged with the upper portion of the tenon 32 to compress and capture the cushion assembly 18 between an upper rate washer 36 and the lower rate washer 26 and within the mount housing 14. The cushion assembly 18 may optionally or additionally be bonded by well known processes to the support surfaces of those components.

The cushion assembly 18 is preferably formed of an elastomer that provides a selected level of damping between the damper rod 11 and the tower 12. To facilitate proper fit and positioning of the cushion assembly 18 relative to the damper rod 11, the upper rate washer 36 and the lower rate washer 26 may be provided with fingers 38 and 40, respectively, that engage the cushion assembly. The shape of the cushion assembly 18 and its physical properties may be altered as necessary to enhance performance of the mount assembly 10 in a manner known in the art. Through this structure, the damper piston rod 11 moves relative to the tower 12 by means of deflection of the elastomeric cushion 18.

Attachment is accomplished by means of a single point connection by virtue of the nut 15 being threaded onto external threads on the mount housing 14. No other fasteners are required to attach the mount assembly 10 to the vehicle tower 12. The nut 15 may also provide the optional feature of serving as a simple camber and caster adjustment mechanism in the associated vehicle suspension system.

Accordingly, an upper mount assembly is provided that is relatively easily attached to the tower of the motor vehicle, includes relatively few individual components, and exhibits tuning and packaging flexibility. Attachment to the vehicle tower is accomplished through a single point type connection system that advantageously expedites assembly of the associated vehicle suspension system. The upper mount is rigidly attached to the vehicle body by trapping the vehicle's tower between two rigid components of the mount while the damper rod tenon is free to move relative to the clamping members of the mount and relative to the tower, while preferably no relative movement occurs between the clamping members of the mount and the tower. Additionally, damper loads are accepted in shear, while a separate path is provided for the vehicle loads.

While the embodiment of the invention disclosed herein is presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A mount assembly for connecting a damper rod to a motor vehicle tower, the mount assembly comprising:
a mount housing having a vertical portion extending through an opening in the tower, and a flange disposed on one side of the tower;
a nut disposed on a side of the tower opposite the one side, the nut being engaged with the vertical portion of the mount housing;
a resilient cushion disposed within the vertical portion of the mount housing, the damper rod extending through the resilient cushion assembly; and
a spring engaged with the tower and adapted to transfer loads from the motor vehicle to the tower.

2. The damper mount assembly of claim 1 further comprising a lower rate washer disposed between the damper rod and the resilient cushion.

3. The damper mount assembly of claim 1 further comprising an upper rate washer engaged with the resilient cushion on the opposite side of the tower.

4. The damper mount assembly of claim 3 further comprising a second nut engaged with the damper rod and engaged with the upper rate washer.

5. The damper mount assembly of claim 1 further comprising a spring seat disposed between the spring and the tower.

6. The damper mount assembly of claim 5 wherein the spring seat is disposed between the spring and the mount housing flange.

7. The damper mount assembly of claim 1 further comprising a bearing disposed between the spring and the tower.

8. The damper mount assembly of claim 7 wherein the bearing is disposed between the spring and the mount housing flange.

9. A mount assembly for connecting a damper rod to a motor vehicle tower, the mount assembly comprising:
a mount housing having a vertical portion extending through an opening in the tower, and a flange disposed on one side of the tower;
a nut disposed on a side of the tower opposite the one side, the nut being engaged with the vertical portion of the mount housing;
a resilient cushion disposed within the vertical portion of the mount housing, the damper rod extending through the resilient cushion assembly;
a spring engaged with the tower and adapted to transfer loads from the motor vehicle to the tower; and
a lower rate washer disposed between the damper rod and the resilient cushion.

10. The damper mount assembly of claim 9 further comprising an upper rate washer engaged with the resilient cushion on the opposite side of the tower.

11. The damper mount assembly of claim 10 further comprising a second nut engaged with the damper rod and engaged with the upper rate washer.

12. The damper mount assembly of claim 9 further comprising a spring seat disposed between the spring and the tower.

13. The damper mount assembly of claim 12 wherein the spring seat is disposed between the spring and the mount housing flange.

14. The damper mount assembly of claim 9 further comprising a bearing disposed between the spring and the tower.

15. The damper mount assembly of claim 14 wherein the bearing is disposed between the spring and the mount housing flange.

16. A mount assembly for connecting a damper rod to a motor vehicle tower, the mount assembly comprising:
a mount housing having a vertical portion extending through an opening in the tower, and a flange disposed on one side of the tower;
a nut disposed on a side of the tower opposite the one side, the nut being engaged with the vertical portion of the mount housing;
a resilient cushion disposed within the vertical portion of the mount housing, the damper rod extending through the resilient cushion assembly;
a spring engaged with the tower and adapted to transfer loads from the motor vehicle to the tower;
a lower rate washer disposed between the damper rod and the resilient cushion; and
an upper rate washer engaged with the resilient cushion on the opposite side of the tower.

17. The damper mount assembly of claim 16 further comprising a second nut engaged with the damper rod and engaged with the upper rate washer.

18. The damper mount assembly of claim 16 further comprising a spring seat disposed between the spring and the mount housing flange.

19. The damper mount assembly of claim 16 further comprising a bearing disposed between the spring and the tower.

20. The damper mount assembly of claim 19 wherein the bearing is disposed between the spring and the mount housing flange.
